(19) United States
(12) Patent Application Publication
(10) Pub. No.: US 2024/0073171 A1
(43) Pub. Date: Feb. 29, 2024

(54) A SYSTEM AND A METHOD FOR TAGGING AND FORWARDING MESSAGE BETWEEN TWO ELECTRONIC DEVICES

(71) Applicant: Bhawana MITRA, Kolkata, West Bengal (IN)

(72) Inventor: Bhawana MITRA, Kolkata, West Bengal (IN)

(21) Appl. No.: 18/553,707

(22) PCT Filed: Apr. 1, 2022
(86) PCT No.: PCT/IN2022/050329

§ 371 Date: Oct. 2, 2023

(30) Foreign Application Priority Data
Apr. 1, 2021 (IN) 202131015594

(51) Int. Cl. H04L 51/214; H04L 51/216

(52) U.S. Cl. CPC H04L 51/214; H04L 51/216

(57) ABSTRACT

The present subject matter relates to a method of exchanging messages between computing devices. The method comprises detecting, in a messaging application running on a first computing device, a user input for forwarding a message of the messaging application. The method further comprises displaying a list comprising a plurality of user-selectable category tags, where each of the plurality of category tag is indicative of a type of the message. The method also includes receiving a selection of a category tag from the user, appending tag information corresponding to the category tag selected by the user to the message, where the tag information comprises an identifier of the tag and a count of the category tag and further transmitting, by the first computing device, the message with the appended tag information to a second computing device over a communication network.

### TECHNICAL FIELD

The present description relates to exchanging messages between computing devices and, more particularly, relates to tagging and forwarding messages between computing devices.

### BACKGROUND

In the recent decade, advancement in technology has greatly enhanced and simplified the manner in which users interact with each other throughout the world. For instance, the infrastructure advancement has enabled deployment of Internet services even in last mile remote areas across the world. Further, with the launch of Internet based instant messaging applications, users are able to send communication messages all across the world at practically near to free costs. This ease of reaching out to other users accompanied with the robust communication platform has led to a significant increase in the volume of text messages being exchanged between communication devices worldwide.

Though the ease of sending and receiving the text messages has greatly enhanced the ease and comfort of communication between the users, at the same time, this has also resulted in accompanying drawbacks as well. For instance, a user may receive messages from other users which may not be of any relevance to the user. On receipt of such messages, the user can only make such an assessment only after reading the message. This, as may be understood, may result in wasting the user's time. Furthermore, in certain cases, such messages may include attachments which are required to be downloaded. Again, without the knowledge of the content, the user first has to download the attachment and then access the same. In case such a message and attachments are not of any relevance, this results in wastage of resources, such as data, in addition to user's time. In case the user is on a limited data usage package, downloading of such attachments results in data exhaustion, and requires further subscription to data packages, thereby resulting in increases economic expenditure for the user. The aforesaid problem further extrapolates when duplicate of such communication messages are received by the user from other users.

Yet further, conventional instant messaging applications nowadays have further simplified forwarding of messages between users by providing dedicated icon(s) for the same. With this ease of forwarding, dissemination of information has become a straightforward and easy task for a sender of a forward message. While measures of forwarding the messages brings in convenience, at the same time, conventional instant messaging applications also provide for a simplified platform for any user who is maliciously seeking to disseminate false information.

### SUMMARY

This summary is provided to introduce concepts related to tagging and forwarding messages between computing devices. These concepts are further described below in the detailed description. This summary is not intended to identify essential features of the claimed subject matter nor is it intended for use in determining or limiting the scope of the claimed subject matter.

In an embodiment, a method of exchanging messages between computing devices is disclosed. The method comprises detecting, in a messaging application running on a first computing device, a user input for forwarding a message of the messaging application. The method further comprises displaying, on a display of the first computing device, a list comprising a plurality of user-selectable category tags, where each of the plurality of category tag is indicative of a type of the message. The method further comprises receiving, by the first computing device, a selection of a category tag from the user. Further, the method comprises appending, by the first computing device, tag information corresponding to the category tag selected by the user to the message, where the tag information comprises an identifier of the tag and a count of the category tag. The method further comprises transmitting, by the first computing device, the message with the appended tag information to a second computing device over a communication network.

In an embodiment, a method of exchanging messages between computing devices is disclosed. The method comprises receiving, by a computing device over a communication network, a forwarded message along with appended tag information, the appended tag information comprising an identifier and a count corresponding to one or more category tags, where category tag is indicative of a type of the message. The method further comprises obtaining the identifier and the count corresponding to the one or more category tags from the tag information. Further, the method comprises displaying, the identifier and the count corresponding to the one or more category tags along with the forwarded message in a message application of the computing device.

In an embodiment, a method of exchanging messages between computing devices is disclosed. The method comprises receiving, by a computing device over a communication network, a forwarded message in a chat thread of a messaging application. The method further comprises determining, by the computing device, whether a copy of the received forwarded message already exists in any of one or more chat threads of the messaging application. Further, the method comprises displaying, a notification message on a display of the computing device when it is determined that the received forwarded message already exists in any one of the chat threads of the messaging application, where the notification message comprises text to notify that the received forwarded message already exists.

In other embodiments, systems for performing the aforementioned methods is disclosed, in accordance with the embodiments of the present subject matter.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 illustrates an example network environment, according to one or more embodiments of the present subject matter;

FIG. 2 illustrates a schematic block diagram of computing devices, according to an embodiment of the present subject matter;

FIG. 3 illustrates a forward message including appended tag information, according to one or more embodiments of the present subject matter;

FIG. 4 illustrates a list of user-selectable category tags, according to one or more embodiments of the present subject matter;

FIG. 5 illustrates a notification message, according to one or more embodiments of the present subject matter;

FIG. 6 illustrates a flowchart of a method of exchanging messages between computing devices, according to an embodiment of the present subject matter;

FIG. 7 illustrates a flowchart of a method of exchanging messages between computing devices, according to an embodiment of the present subject matter; and

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Conventional Internet based instant messaging application provides users with ease of communicating with other users at reduced costs. For example, two users who are registered with an instant messaging application may send each other communication messages over the Internet using the instant messaging application. Examples of such communication messages may include, but are not limited to, text messages, audio messages, video messages, etc.

While a user typically composes a message and subsequently sends the same to an intended recipient, another feature of such conventional messaging applications provides the user with an option for forwarding messages. The instant messaging application includes an option, typically in the form of a graphical icon or a menu option, for forwarding a message. Thus, a user seeking to forward a message may, at first, select the intended message, press the option for forwarding the message, and select the intended recipient. Once confirmation on the recipient(s) is received, the message is then sent to the intended recipient.

On receiving the message, the intended recipient has to go through the content of the message and accordingly determine if the content of the message is useful or not to him. Further, in case where the content includes some facts or information, the recipient then has to himself make the efforts of verifying whether such facts or information is true or not.

With increasing volume of such forwards being received every day, determining the relevance of content of such forward messages becomes a cumbersome, tedious, and time and resource consuming task for the recipient. For instance, the recipient has to spend his time and resources, such as data, for viewing the content and for further verification of the content, as the case may be. Such pain points are further increased in cases where duplicate forward messages are received by the recipient.

To put the aforesaid point in correct perspective, a statistical example with reference to Indian geographic location is given below. As would be appreciated, similar statistical implications for other geographic locations may also apply.

There are a total of 340 million users of a conventional messaging application in India alone. If even 10% of the users get any duplicate forwards, those would be 34 million people. Even if every user spends just 30 seconds on a duplicate forward, that makes it 17 million minutes of wasted time which roughly translates to 17 million/(60) hrs=283333.33 manhours wasted per day.

From a productivity point of view, if a working man devotes 10 hours per day to work, this wastage amounts to a wastage of 28333.33 mandays per day or roughly 9444.44 man months per day or 787.04 Manyears per day. At current rate of Rs 1,26,970 as Per Capita Income for FY 2021, this means a notional loss or wastage of 787.04*26970=Rs 9,99,30,468 and 80 Paise per day or a wastage of Rs 36,47,46,21,112 i.e. Rs 3647 Crores 46 Lakhs 21 Thousand One Hundred and Twelve per year or 496.794 Million USD per year as per prevailing exchange rate.

As would be appreciated, similar statistical implications for other geographic locations may also apply and would be understood by a person skilled in the art.

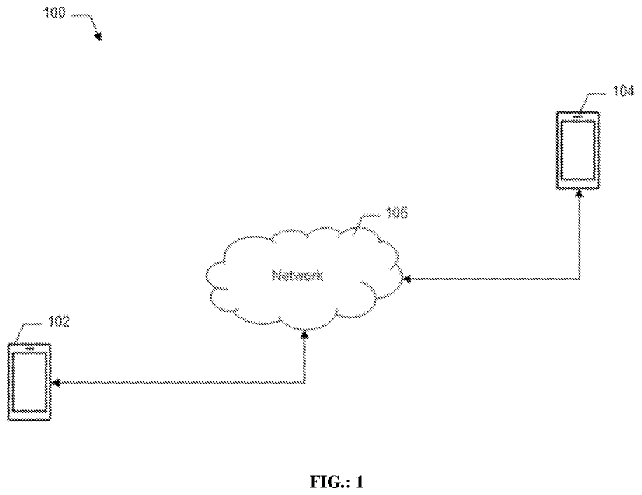

FIG. 1 illustrates an example network environment 100, according to an embodiment of the present subject matter. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

In an example, the network environment 100 may include a first computing device 102, a second computing device 104, and a network 106. The network 106 may communicatively (directly or indirectly) couple the first computing device 102 and the second computing device 104. In one or more implementations, the network 106 may be an interconnected network of devices that may include, or may be communicatively coupled to, the Internet. For explanatory purposes, the network environment 100 is illustrated in FIG. 1 as including the first computing device 102 and the second computing device 104; however, the network environment 100 may include any number of electronic devices and other network devices.

Examples of the first computing device 102 and second computing device 104 may include but are not limited to a desktop computer, a portable computing device such as a laptop computer, a smartphone, a tablet device, a wearable device such as a smartwatch, a band, and the like. In FIG. 1, by way of example, the first computing device 102 and the second computing device 104 are depicted as a smartphone.

In an example embodiment, the first computing device 102 may be configured to detect in a messaging application running on the first computing device 102, a user input for forwarding a message of the messaging application. Examples of the messaging application may include, but are not limited to, a stock messaging application, a third-party chat application, a messenger application, and an email application.

In an example, a user of the messaging application may seek to forward a message to another user using the messaging application. Accordingly, the user may provide a user input in the form of a touch input on a specific icon in a user interface being displayed on the first computing device 102 which is correlated with the function of forwarding a selected message. In another example, the user input may be in the form of a voice command received by the first computing device 102. In said example, the user may first give a voice command to select a message which is intended to be forwarded to the other user. Subsequently, the user may give another voice command for forwarding the selected message.

In yet another example, the user input may be in the form of a gesture command made by the user. In said example, the user may first select a message using a first gesture. Subsequently, the user may perform a second gesture for forwarding the selected message.

Once the first computing device 102 detects the user input for forwarding the message, the first computing device 102 may provide a list of contacts to which the user intends to forward the message. Accordingly, the user may provide another user input for selecting one or more contacts to whom the selected message is to be forwarded.

Subsequently, the first computing device 102 may display a list comprising a plurality of user-selectable category tags. Each of the category tag is indicative of a type of the message. For instance, a category tag ‘Verified’ indicates a message whose content is verified. Aa category tag ‘Unverified’ indicates a message whose content is unverified. Likewise, other examples of category tags may include, but are not limited to, Infotainment, Violent, and Inciteful.

From the list of user-selectable category tags, the user may provide a selection of a category tag. Accordingly, the first computing device 102 may receive the selection of the category tag from the user. The first computing device 102 subsequently appends tag information corresponding to the category tag selected by the user to the message. Appending of the tag information may be understood as including the identifier and the count of the selected category tag in the graphical icon of the forward message. The tag information, in an example, may include, an identifier, such a symbol, indicative of the category tag and a count of the category tag.

Once the appending is completed, the first computing device 102 then transmits the message with the appended tag information to the second computing device 104 over a communication network.

The above embodiment describes a scenario where a user of the first computing device 102 forwards a message to another user. Likewise, in an embodiment, the first computing device 102 may receive a forwarded message in accordance with the aspects of the present subject matter. Accordingly, in said embodiment, the first computing device 102 may be configured to receive a forwarded message along with appended tag information. The tag information herein may include an identifier and a count corresponding to one or more category tags.

After receiving the message, the first computing device 102 may be configured to obtain the identifier and the count corresponding to each of the one or more category tags. Once the identifier and the count corresponding to the one or more category tags are obtained, the first computing device 102 may display the identifier and the count corresponding to the one or more category tags along with the forwarded message in a message application of the first computing device 102.

In yet another embodiment, aspects of the present subject matter provide for identifying and alerting a user in case multiple same forwards are being received by the first computing device 102. In said embodiment, the first computing device 102 may be configured to receive a forwarded message in a chat thread of a messaging application. Subsequently, the first computing device 102 may make a determination as to whether a copy of the received forwarded message already exists in any one of one or more chat threads of the messaging application.

In case it is determined that the received forwarded message already exists in any one of the chat threads of the messaging application, the first computing device 102 may display a notification message on a display of the first computing device 102. The notification message, in an example, includes text to notify that the received forwarded message already exists.

Thus, as the received forwarded message includes category tags and counts, a recipient thereof is easily and upfront able to determine the relevance of the message for the recipient. For instance, based on the category tag(s) and associated count, the recipient may gauge whether the content is of interest to him. As an example, a received forwarded may include an attachment and may be appended with category tag infotainment. Accordingly, the recipient may determine that he/she is not interested in viewing the contents and may choose to not download the attachment. Thus, resources, such as data are efficiently utilized. Furthermore, the recipient may also be able to make a determination as to authenticity of the content in cases where category tags, such as verified or unverified are appended. Based on such tags, the recipient can further forward such messages or chose against forwarding such messages. For instance, in case a received forwarded message has a category tag unverified associated therewith with a high count, the recipient may refrain from forwarding such messages. Thus, menace associated with forwarding of unverified messages may be averted.

Yet further, the aforementioned aspects provide for learning of presence of duplicate forward messages and accordingly providing the user with an upfront option to delete or view such messages. This, as would be appreciated, may result in avoiding downloading of already downloaded content, thereby reducing data consumption.

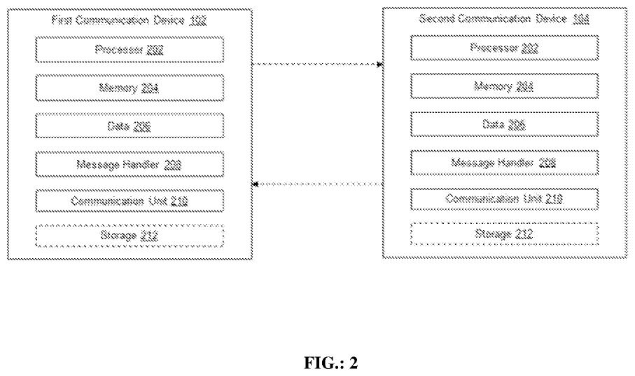

FIG. 2 illustrates a schematic block diagram of the computing devices 102 and 104, according to an example embodiment of the present subject matter. In an example, each of the computing devices 102 and 104 may include a processor 202, memory 204 (memory device), data 206, a message handler 208, and a communication unit 210. Although, the aforementioned components have been shown as integral to the computing devices 102 and 104, as would be appreciated, one or more of the aforementioned components may be provided in other devices. Examples of such other devices may include, for example, a server or a remote server which is hosting the application.

In an example, the processor 202 may be a single processing unit or a number of units, all of which could include multiple computing units. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 is configured to fetch and execute computer-readable instructions and data stored in the memory 204.

The memory 204 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The data 206 serves, amongst other things, as a repository for storing data processed, received, and generated by one or more of the processor 202. Writing further, in a non-limiting manner, one or more of the aforementioned components of the computing devices 102 and 104 may send or receive data, for example, using one or more input/output ports and one or more communication units.

The message handler 208, amongst other things, include routines, programs, objects, components, data structures, etc., which perform particular tasks or implement data types. The message handler 208 may also be implemented as, signal processor(s), state machine(s), logic circuitries, and/or any other device or component that manipulate signals based on operational instructions.

Further, the message handler 208 can be implemented in hardware, instructions executed by a processing unit, or by a combination thereof. The processing unit can comprise a computer, a processor, such as the processor 202, a state machine, a logic array or any other suitable devices capable of processing instructions.

In another aspect of the present subject matter, the message handler 208 may be machine-readable instructions (software) which, when executed by a processor/processing unit, perform any of the described functionalities. The machine-readable instructions may be stored on an electronic memory device, hard disk, optical disk or other machine-readable storage medium or non-transitory medium. In one implementation, the machine-readable instructions can be also be downloaded to the storage medium via a network connection.

In an example, the communication unit 210 may include one or more hardware units that support wired or wireless communication between the processor 202 and processors of other computing devices. Furthermore, in an example, the computing devices 102 and 104 may include or may be communicatively coupled with a storage 212. The storage 212 may be either an internal storage or an external storage.

In an example, a user of the first computing device 102 may seek to forward a message to a user of the second computing device 104. To that end, in the first computing device 102, the message handler 208 may be configured to detect a user input for forwarding the message of a messaging application. The user input may be one of a touch input, a voice input, or a gesture-based input. Accordingly, the message handler 208 may operatively communicate with the requisite hardware and/or software of the first computing device 102 for detecting the user input.

After detecting the user input, the message handler 208 may be configured to display a list of user-selectable category tags on a display of the first computing device 102. Each of these user-selectable category tags indicate a type of the message. More particularly, the category tags indicate a type of the content of the message. Examples of the category tags may include, but are not limited to, Verified, Unverified, Infotainment, Violent, Inciteful, and Inappropriate.

From amongst the displayed user-selectable category tags, the user may make a selection of a category tag and said selection is received by the message handler 208. The selection, as would be understood, is made through a user input by the user. Furthermore, in one operation of forwarding of the message, only one category tag may be selected by the user. Subsequently, the message handler 208 may append tag information corresponding to the category tag selected by the user to the message. As mentioned above, the tag information includes an identifier and a count of the category tag.

In an example where the message is being forwarded for a first time, the tag information will include only the identifier and the count of the selected category tag. Thus, in this instance, the count of the selected category would be one.

In another example, wherein the message selected by the user is a forwarded message, the message may already have tag information appended to it. In such a case, the message handler 208 may be configured to update the already existing tag information and subsequently append it to the selected message. For instance, the message handler 208 may be configured to obtain the tag information already appended to the forwarded message and ascertain a current count, say X, of the category tag selected by the user. Based on the user selection of the category tag, the message handler 208 may be configured to update the current count to X+1. After updating the current count, the message handler 208 may then append the updated tag information to the forwarded message.

In an example, where the already appended tag information does not include the user-selected category tag, the message handler then updates the appended tag information to include the identifier and the count of the category tag. In this case, the count would then be one.

In another example, the message handler 208 may be configured to decrease a current count of at least one other category tag. For instance, consider a case where a message has appended tag information which includes category tags verified with a current count X and unverified with a current count Y. Now, in case the user has selected the category tag verified, in such a case, the message handler 208 may be configured to increase the current count of verified to X+1 and decrease a current count of the unverified category tag to Y−1. Subsequently, the message handler 208 may append the updated tag information to the forwarded message.

Thus, as explained above, the message handler 208 may be configured to append the tag information to the selected message in various manners. Once the tag information is appended, the message handler 208 may be configured to transmit the message with the appended tag information to the second computing device 104 over the communication network using the communication unit 210.

In an example embodiment, at the second computing device 104, the communication unit 210 may be configured to receive the forwarded message along with appended tag information. The appended tag information may comprise an identifier and a count corresponding to one or more category tags. As mentioned above, the category tags are indicative of a type of the message. In case where the forward message is a first time forwarded message, the tag information may include the identifier and count of only one category tag. In another case, where the forwarded message has been forwarded multiple times, the tag information is most likely to include the identifier and count of more than one category tags.

On receiving the forwarded message, the message handler 208 of the second computing device 104 may be configured to obtain the identifier and the count corresponding to the one or more category tags from the tag information. Subsequently, the message handler 208 may display the identifier and the count corresponding to the one or more category tags along with the forwarded message in a message application of the second computing device 104.

According to a further example embodiment of the present subject matter, the message handler 208 may be configured to identify and alert a user in case a duplicate forward message is received. In said embodiment, the communication unit 210 may be configured to receive a forwarded message in a chat thread of a messaging application. Subsequently, the message handler 208 may be configured to determine whether a copy of the received forwarded message already exists in any of one or more chat threads of the messaging application.

For determining whether a copy of the received forwarded message already exists in any of one or more chat threads of the messaging application, in an example implementation, the message handler 208 may be configured to obtain a unique identity (ID) associated with the received forwarded message. The unique ID, in an example, may be a Universally Unique Identifier (UUID) and may be of 128-bit value. The UUID is also known conventionally known and referred to as Globally Unique Identifiers (GUID). In an example, the unique ID may be created by the message handler 208 using conventional techniques, as and when a new message is composed and sent by a user. Thus, each new message may have a unique ID associated therewith. In other cases, when a message is received by the computing device, the message handler 208 may access the related metadata of the received message and may ascertain the unique ID related to the received message.

In an example, the message handler 208 may be configured to store the unique IDs associated with the messages pertaining to the chat thread of the computing device, such as the first computing device 102 and the second computing device 104. In an example, the unique IDs may be stored on the computing device itself or in another example, may be stored on a server pertaining to the messaging application.

As mentioned above, the message handler 208 may be configured to obtain the unique ID associated with the received forwarded message. Thus, obtaining of the unique ID may be understood as accessing the metadata associated with the received forwarded message and reading the unique ID of the received forwarded message by the message handler 208. Subsequently, the message handler 208 may compare the obtained unique ID with a set of stored unique IDs. Accordingly, in case the unique ID already exists in the set of stored unique IDs, the message handler 208 may determine that a copy of the received forwarded message already exists in any one or more chat threads of the messaging application.

On determining that a copy of the received forwarded message already exists in any one or more chat threads of the messaging application, the message handler 208 may be configured to display a notification message on a display of the second computing 104. The notification message comprises text to notify that the received forwarded message already exists.

In an example embodiment, the notification message may further include a first user-selectable option and a second user-selectable option. The first user-selectable option may provide the user with the option of deleting the received forwarded message. The second user-selectable option may provide the user with the option of viewing the received forwarded message. Thus, besides the text to notify that the received forwarded message already exists, the message handler 208 may also provide the aforesaid two options to the user.

Accordingly, in an example embodiment, the user may choose to delete the duplicate forward message and the message handler 208 may receive a selection of the first user-selectable option from the user. In response to the received selection of the first user-selectable option, the message handler 208 may delete the received forwarded message.

In another example embodiment, the user may choose to view the duplicate forward message and the message handler 208 may receive a selection of the second user-selectable option from the user. In response to the received selection of the second user-selectable option, the message handler 208 may display the received forwarded message on the display of the second computing device 104.

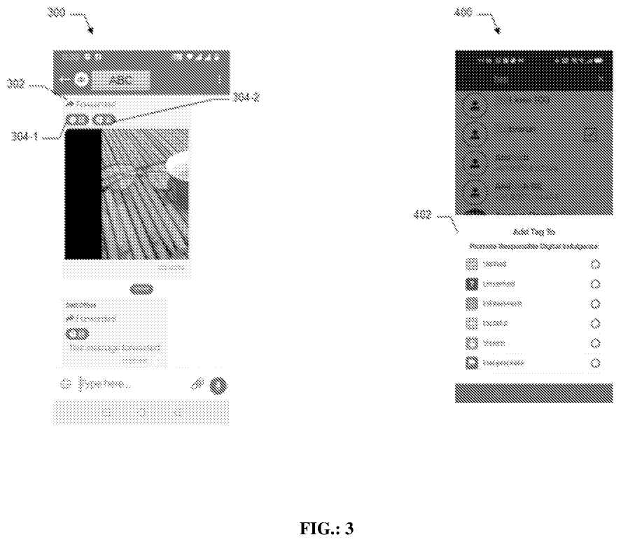

FIG. 3 illustrates a forward message including appended tag information, according to one or more embodiments of the present subject matter. As shown in the FIG. 3, a Graphical User Interface (GUI) 300 of a message application is shown. The GUI 300 depicts a group chat thread in which a forwarded message 302 is depicted. According to aspects of the present subject matter, the forwarded message 302 has tag information appended. Accordingly, the forwarded message 302 includes a category tag 304-1 along with count of one and a category tag 304-2 along with corresponding count of one. The category tag 304-1 includes an identifier corresponding to the category tag verified. Likewise, the category tag 304-2 includes an identifier corresponding to the category tag violent.

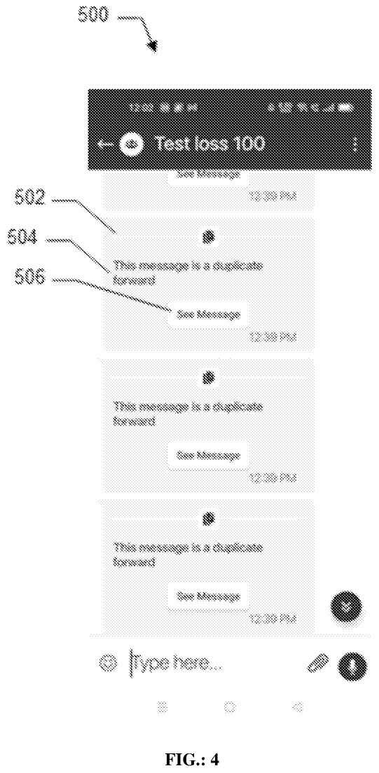

FIG. 4 illustrates a list of user-selectable category tags, according to one or more embodiments of the present subject matter. As shown in FIG. 4, a GUI 400 of a messaging application is shown. In an example, the GUI 400 may be presented to the user after the user has selected a message and provided a user input for forwarding the selected message. In another example, the GUI 400 may be presented to the user after the user has selected a message, provided a user input for forwarding the selected message, and selected the contact(s) to whom the selected message is to be forwarded. In the FIG. 4, the GUI 400 depicts a scenario where a list 402 of user-selectable category tags is presented to the user after the user has selected a message, provided a user input for forwarding the selected message, and selected the contact(s) to whom the selected message is to be forwarded. The list 402, as can be seen, includes category tags, such as verified, unverified, infotainment, inciteful, violent, and inappropriate. According to aspects of the present subject matter, the user may add any one of the aforementioned category tags to the selected message which is to be forwarded.

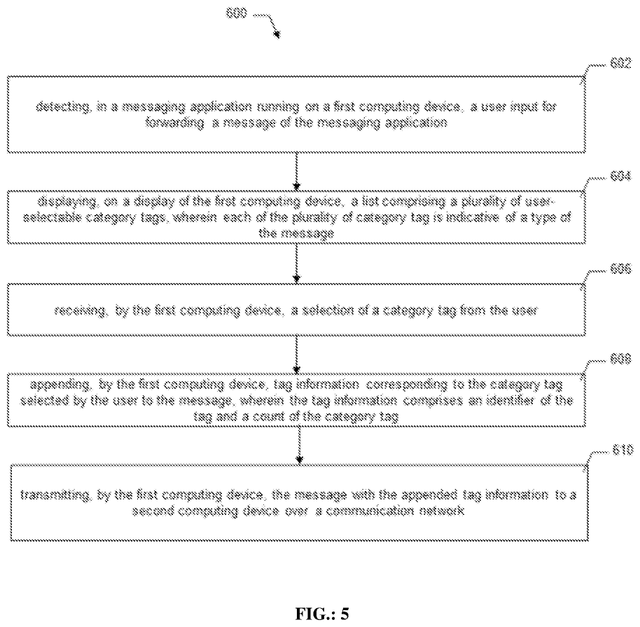

FIG. 5 illustrates a notification message, according to one or more embodiments of the present subject matter. In FIG. 5, a GUI 500 of a chat thread is shown. In an example, when the message handler determines that a copy of the received forwarded message already exists, the message handler 208 may display a notification message such as the notification message 502. The notification message 502 may include text 504 to notify the user that the received forwarded message already exists. As an example, the text 504 may read: “This message is a duplicate forward.” As is further shown, the notification message 502 may further include an option 506. The option 506 is a user-selectable option which, upon selection by the user, displays the received forwarded message to the user. According to further aspects of the present subject matter, another option (not shown in the figure) for deleting the duplicate forward message may be provided to the user. Upon selection of this other option, the received forwarded message may be deleted.

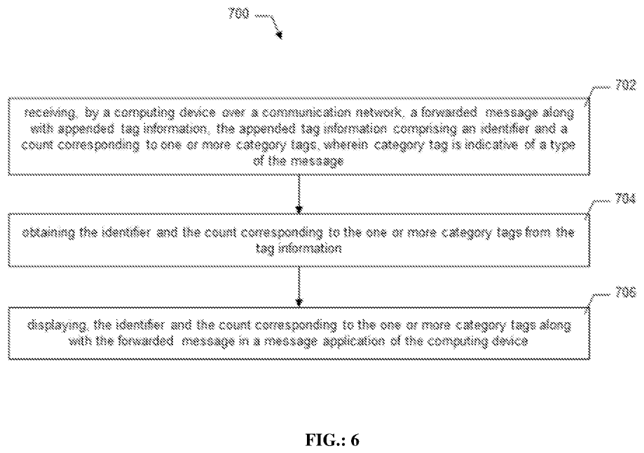

FIG. 6 illustrates a flowchart of a method 600, according to an embodiment of the present subject matter. In an example, the method 600 may be implemented in a computing device, such as the first computing device 102 and the second computing device 104. Furthermore, details of the steps of the method 600 which are already described herein in the above figures are not included in detail herein.

At step 602, the method 600 includes detecting, in a messaging application running on a first computing device, a user input for forwarding a message of the messaging application. The user input may be in the form of a long press on a screen of the first computing device to select a message. Subsequently, an icon for forwarding the selected message may be selected by the user. In an example, the step may be performed by the message handler 208.

At step 604, the method 600 includes displaying, on a display of the first computing device, a list comprising a plurality of user-selectable category tags, wherein each of the plurality of category tag is indicative of a type of the message. The list may include a predefined number of category tags. In one operation of forwarding of a message, only one category tag may be assigned by the user. Examples of the category tags may include, but are not limited to, Verified, Unverified, Infotainment, Violent, Inciteful, and Inappropriate. In an example, the step may be performed by the message handler 208.

At step 606, the method 600 includes receiving, by the first computing device, a selection of a category tag from the user. On displaying the list, the user may make a selection of a particular category tag, for instance, based on the user's judgement of the content of the message. In an example, the step may be performed by the message handler 208.

At step 608, the method 600 includes appending, by the first computing device, tag information corresponding to the category tag selected by the user to the message, where the tag information comprises an identifier of the tag and a count of the category tag. Appending of the tag information may be understood as including the identifier and the count of the selected category tag in the graphical icon of the forward message. In an example, the step may be performed by the message handler 208.

At step 610, the method 600 includes transmitting, by the first computing device, the message with the appended tag information to a second computing device over a communication network. Once the tag information is appended, the message may be transmitted to the second computing device. In an example, the step may be performed by the communication unit 210.

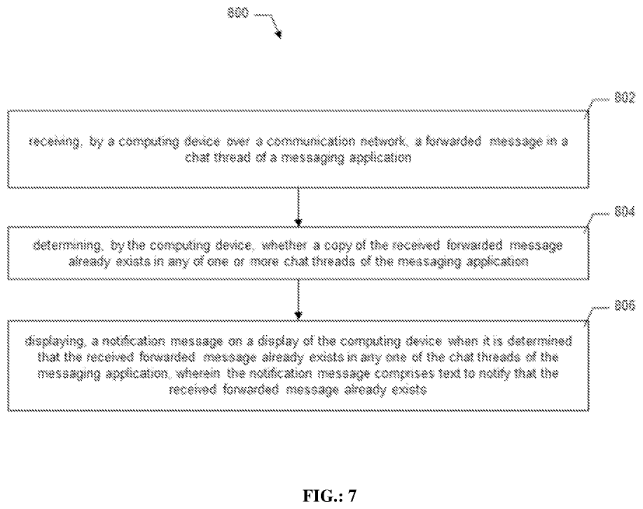

FIG. 7 illustrates a flowchart of a method 700, according to an embodiment of the present subject matter. In an example, the method 700 may be implemented in a computing device, such as the first computing device 102 and the second computing device 104. Furthermore, details of the steps of the method 700 which are already described herein in the above figures are not included in detail herein.

At step 702, the method 700 includes receiving, by a computing device over a communication network, a forwarded message along with appended tag information, the appended tag information comprising an identifier and a count corresponding to one or more category tags, where category tag is indicative of a type of the message. In an example, the step may be performed by the communication unit 210.

At step 704, the method 700 includes obtaining the identifier and the count corresponding to the one or more category tags from the tag information. In an example, the step may be performed by the message handler 208.

At step 706, the method 700 includes displaying, the identifier and the count corresponding to the one or more category tags along with the forwarded message in a message application of the computing device. In an example, the step may be performed by the message handler 208.

FIG. 8 illustrates a flowchart of a method 800, according to an embodiment of the present subject matter. In an example, the method 800 may be implemented in a computing device, such as the first computing device 102 and the second computing device 104. Furthermore, details of the steps of the method 800 which are already described herein in the above figures are not included in detail herein.

At step 802, the method 800 includes receiving, by a computing device over a communication network, a forwarded message in a chat thread of a messaging application. In an example, the step may be performed by the communication unit 210.

At step 804, the method 800 includes determining, by the computing device, whether a copy of the received forwarded message already exists in any of one or more chat threads of the messaging application. For making the aforesaid determination, a unique ID of the received forwarded message is compared with a stored set of unique IDs. In case the unique ID of the received forward message is found in the stored set of unique IDs, it is determined that a copy of the received forward message exists. In an example, the step may be performed by the message handler 208.

At step 806, the method 800 includes displaying, a notification message on a display of the computing device when it is determined that the received forwarded message already exists in any one of the chat threads of the messaging application, where the notification message comprises text to notify that the received forwarded message already exists. In an example, the step may be performed by the message handler 208.

The foregoing descriptions of exemplary embodiments of the present disclosure have been presented for purposes of illustration and description. They are not intended to be exhaustive or to limit the disclosure to the precise forms disclosed, and obviously many modifications and variations are possible in light of the above teaching. The exemplary embodiment was chosen and described in order to best explain the principles of the disclosure and its practical application, to thereby enable others skilled in the art to best utilize the disclosure and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present disclosure.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

While specific language has been used to describe the disclosure, any limitations arising on account of the same are not intended. As would be apparent to a person in the art, various working modifications may be made to the apparatus in order to implement the inventive concept as taught herein.

We claim:

1. A method of exchanging messages between computing devices, the method comprising:
detecting, in a messaging application running on a first computing device, a user input for forwarding a message of the messaging application;
displaying, on a display of the first computing device, a list comprising a plurality of user-selectable category tags, wherein each of the plurality of category tag is indicative of a type of the message;
receiving, by the first computing device, a selection of a category tag from the user;
appending, by the first computing device, tag information corresponding to the category tag selected by the user to the message, wherein the tag information comprises an identifier of the tag and a count of the category tag; and
transmitting, by the first computing device, the message with the appended tag information to a second computing device over a communication network.

2. The method as claimed in claim 1, wherein the message selected by the user is a forwarded message, wherein the step of appending further comprises:
obtaining tag information already appended to the forwarded message;
ascertaining a current count of the category tag selected by the user based on the obtained tag information associated with the forwarded message; and
updating the current count of the category tag based on the user selection; and
appending the updated tag information to the forwarded message.

3. The method as claimed in claim 2, wherein the method further comprises:
decreasing a current count of at least one other category tag;
updating the current count of the at least one other category tag; and
appending the updated tag information to the forwarded message.

4. The method as claimed in claim 2, further comprising:
receiving the forwarded message along with the appended tag information, the appended tag information comprising an identifier and a count corresponding to one or more category tags, wherein category tag is indicative of a type of the message;
obtaining the identifier and the count corresponding to the one or more category tags from the tag information; and
displaying, the identifier and the count corresponding to the one or more category tags along with the forwarded message in a message application of the computing device.

5. A method of exchanging messages between computing devices, the method comprising:
receiving, by a computing device over a communication network, a forwarded message in a chat thread of a messaging application;
determining, by the computing device, whether a copy of the received forwarded message already exists in any of one or more chat threads of the messaging application;
displaying, a notification message on a display of the computing device when it is determined that the received forwarded message already exists in any one of the chat threads of the messaging application, wherein the notification message comprises text to notify that the received forwarded message already exists.

6. The method as claimed in claim 5, wherein the determining further comprises:
obtaining a unique identity (ID) associated with the received forwarded message;
comparing the obtained unique ID with a set of stored unique IDs; and
determining that a copy of the received forwarded message already exists in any of one or more chat threads of the messaging application, when the obtained unique ID is found in the set of stored unique IDs.

7. The method as claimed in claim 5, wherein the notification message further comprises a first user-selectable option for deleting the received forwarded message and a second user-selectable option for viewing the received forward message.

8. The method as claimed in claim 7, wherein the method further comprises:
receiving, a selection of the first user-selectable option from the user; and
deleting the received forwarded message in response to the selection of the first user-selectable option.

9. The method as claimed in claim 7, wherein the method further comprises:
receiving, a selection of the second user-selectable option from the user; and
displaying the received forwarded message on a display of the computing device in response to the selection of the second user-selectable option.

10. A system for exchanging messages between computing devices, the system comprising:
a display;
a processor;
a memory coupled to the processor;
a message handler coupled to the processor, the message handler configured to:
detect, in a messaging application running on a first computing device, a user input for forwarding a message of the messaging application;
display, using the display of the first computing device, a list comprising a plurality of user-selectable category tags, wherein each of the plurality of category tag is indicative of a type of the message;
receive a selection of a category tag from the user; and
append tag information corresponding to the category tag selected by the user to the message, wherein the tag information comprises an identifier of the tag and a count of the category tag; and
a communication unit coupled to the processor, the communication unit configured to transmit the message with the appended tag information to a second computing device over a communication network.

11. The system as claimed in claim 10, wherein the message selected by the user is a forwarded message, wherein the message handler is further configured to:
obtain tag information already appended to the forwarded message;
ascertain a current count of the category tag selected by the user based on the obtained tag information associated with the forwarded message;
update the current count of the category tag based on the user selection; and
append the updated tag information to the forwarded message.

12. The system as claimed in claim 11, wherein the message handler is further configured to:
decrease a current count of at least one other category tag;
update the current count of the at least one other category tag; and
append the updated tag information to the forwarded message.

13. The system as claimed in claim 11, wherein:
the communication unit is further configured to receive the forwarded message along with the appended tag information, the appended tag information comprising an identifier and a count corresponding to one or more category tags, wherein category tag is indicative of a type of the message; and
the message handler is further configured to:
obtain the identifier and the count corresponding to the one or more category tags from the tag information; and
display, the identifier and the count corresponding to the one or more category tags along with the forwarded message in a message application of the computing device.

14. A system for exchanging messages between computing devices, the system comprising:
a display;
a processor;
a memory coupled to the processor;
a communication unit coupled to the processor, the communication unit configured to receive a forwarded message in a chat thread of a messaging application of a computing device; and
a message handler coupled to the processor, the message handler configured to:
determine whether a copy of the received forwarded message already exists in any of one or more chat threads of the messaging application; and
display, a notification message on a display of the computing device when it is determined that the received forwarded message already exists in any one of the chat threads of the messaging application, wherein the notification message comprises text to notify that the received forwarded message already exists.

15. The system as claimed in claim 14, wherein the message handler is further configured to:
obtain a unique identity (ID) associated with the received forwarded message;
compare the obtained unique ID with a set of stored unique IDs; and
determine that a copy of the received forwarded message already exists in any of one or more chat threads of the messaging application, when the obtained unique ID is found in the set of stored unique IDs.

16. The system as claimed in claim 14, wherein the notification message further comprises a first user-selectable option for deleting the received forwarded message and a second user-selectable option for viewing the received forward message.

17. The system as claimed in claim 16, wherein the message handler is further configured to:
receive, a selection of the first user-selectable option from the user; and
delete the received forwarded message in response to the selection of the first user-selectable option.

18. The system as claimed in claim 16, wherein the message handler is further configured to:
receive, a selection of the second user-selectable option from the user; and
display the received forwarded message on a display of the computing device in response to the selection of the second user-selectable option.
